(19) United States
(12) Patent Application Publication
(10) Pub. No.: US 2025/0117962 A1
(43) Pub. Date: Apr. 10, 2025

(54) SIDE BRANCH DETECTION FROM ANGIOGRAPHIC IMAGES

(71) Applicant: Boston Scientific Scimed, Inc., Maple Grove, MN (US)

(72) Inventors: Yan Li, Plymouth, MN (US); Kevin Bloms, Minneapolis, MN (US); Wenguang Li, Los Gatos, CA (US)

(73) Assignee: Boston Scientific Scimed, Inc., Maple Grove, MN (US)

(21) Appl. No.: 18/903,046

(22) Filed: Oct. 1, 2024

Related U.S. Application Data
(60) Provisional application No. 63/588,546, filed on Oct. 6, 2023.

(51) Int. Cl. G06T 7/73; G06T 7/62; G06V 10/74

(52) U.S. Cl. CPC G06T 7/73; G06T 7/62; G06V 10/74; G06T 2207/10081; G06T 2207/10101; G06T 2207/10116; G06T 2207/10132; G06T 2207/20081; G06T 2207/30101; G06T 2207/30172; G06V 2201/03

(57) ABSTRACT

The present disclosure provides to generate a 3D visualization of a vessel from intravascular ultrasound (IVUS) images. In particular, the present disclosure provides to reduce jitter between frames of an IVUS recording to provide a smoother appearance of a longitudinal view of the vessel from the IVUS image frames and to construct a 3D visualization of the vessel from the jitter compensated IVUS image frames.

### CROSS-REFERENCE TO RELATED APPLICATIONS

This application claims the benefit of U.S. Provisional Patent Application Ser. No. 63/588,546 filed on Oct. 6, 2023, the disclosure of which is incorporated herein by reference.

### TECHNICAL FIELD

The present disclosure pertains to computerized tomography (CT) coronary angiography and to co-registration of CT coronary angiograms with intravascular imaging modalities.

### BACKGROUND

CT coronary angiography (CTA or CCTA) is the use of CT angiography to assess the coronary arteries of the heart. Typically, a patient receives an intravenous injection of contrast agent and then the heart is scanned using a high speed CT scanner. CTA is often used in conjunction with other imaging modalities, such as, intravascular ultrasound (IVUS) or intravascular optical CT (OCT). A physician will use the CTA and the IVUS or intravascular OCT images to assess the extent of occlusion(s) in the coronary arteries, usually to diagnose coronary artery disease.

To aid physicians in reviewing these images, they can be co-registered to each other. For example, each image in a series of IVUS images can be mapped, or co-located, to a position of the vessel represented in the CTA image. Accordingly, there is a need to identify fiducials in each type of image and map these fiducials to each other.

### BRIEF SUMMARY

The present disclosure provides to identify side branch locations from angiography images and to extract essential information about the side branches. For example, the disclosure can be implemented to identify a side branch as well as the size (e.g., diameter, or the like) and orientation of the side branch from an angiographic image.

It will be appreciated that side branches serve as crucial fiducials (or landmarks) in CT coronary angiography and are often used during co-registration and the CT coronary angiographic image with intravascular images (e.g., IVUS, or the like). The present disclosure can be implemented as part of a co-registration technique to improve the alignment between an angiographic image and a series of intravascular images.

In further embodiments, the present disclosure can be implemented to identifying the axial orientation and/or myocardium locations in intravascular images (e.g., IVUS images, or the like), which can enable more precise interpretation of intravascular images by a physician. With other embodiments, the identified side branches, and their characteristics (e.g., size, orientation, etc.) can be utilized to generate three-dimensional (3D) models of the vessel, thereby facilitating a comprehensive visualization and analysis of the vessel.

With some embodiments, the disclosure is implemented as a method for a cross-modality side branch matching system. The method can comprise receiving, at a computing device, an image frame associated with a vessel of a patient; identifying, by the computing device, from the image frame based in part on one or more of a plurality of machine learning (ML) models, a location and characteristic of one or more side branches; and matching, by the computing device, the one or more side branches with one or more side branches identified from a series of images, wherein the image frame and the series of images are captured with different image modalities.

In further embodiments of the method, the characteristic is an orientation of the one or more side branches, a diameter of the one or more side branches, or both an orientation and a width of the one or more side branches.

In further embodiments of the method, the characteristics of orientation and diameter of the one or more side branches are inputs for a cross-modality side branch matching process between extravascular and intravascular imaging modalities, wherein the extravascular imaging modality is x-ray angiography or computed tomography angiography, and wherein the intravascular imaging modality is intravascular ultrasound or intravascular optical coherence tomography.

In further embodiments of the method, the locations of the one or more side branches are inputs for a cross-modality side branch matching process between extravascular and intravascular imaging modalities, wherein the extravascular imaging modality is x-ray angiography or computed tomography angiography, and wherein the intravascular imaging modality is intravascular ultrasound or intravascular optical coherence tomography.

In further embodiments of the method, identifying the location and characteristic of the one or more side branches further comprises: inferring, using a first ML model of the plurality of ML models, a segmented version of the image frame, wherein the segmented version of the image frame comprises an indication of the vessel; inferring, using a second ML model of the plurality of ML models, a straightened vessel from the vessel indicated in the segmented version of the image frame; and identifying the one or more side branches from the straightened vessel.

In further embodiments of the method, identifying the one or more side branches from the straightened vessel further comprises splitting the straightened vessel into a left component and a right component; generating a first plot of connected pixels for the left component and generating a second plot of connected pixels for the right component; and determining the location of the one or more side branches based on first plot and the second plot.

In further embodiments of the method, identifying the one or more side branches from the straightened vessel further comprises determining the width of the one or more side branches based on the first plot and the second plot.

In further embodiments of the method, identifying the one or more side branches from the straightened vessel further comprises determining an orientation of the one or more side branches based on the first plot and the second plot.

In further embodiments of the method, the orientation is a left side or a right side orientation.

In further embodiments of the method, identifying the one or more side branches from the straightened vessel further comprises tracing, by the computing device, a skeleton of the straightened vessel; extracting, by the computing device, a centerline of the straightened vessel from the skeleton; tracing, by the computing device, the one or more side branches of the vessel based on the skeleton and the centerline; and determining a location of the one or more side branches of the vessel based on the tracing of the one or more side branches.

In further embodiments of the method, identifying the one or more side branches from the straightened vessel further comprises determining the width of the one or more side branches based on the tracing of the one or more side branches.

In further embodiments of the method, identifying the one or more side branches from the straightened vessel further comprises determining the orientation of the one or more side branches based on the tracing of the one or more side branches.

In further embodiments of the method, the orientation is a left side or a right side orientation.

With some embodiments, the disclosure is implemented as a computer-readable storage device. The computer-readable storage device can comprise instructions executable by a processor of a computing device coupled to an intravascular imaging device and a fluoroscope device, wherein when executed the instructions cause the computing device to implement any of the methods disclosed herein.

With some embodiments, the disclosure is implemented as an apparatus. The apparatus can comprise a processor arranged to be coupled to an intravascular imaging device and a fluoroscope device, the apparatus further comprising a memory comprising instructions, the processor arranged to execute the instructions to implement any of the methods disclosed herein.

With some embodiments, the disclosure is implemented as an apparatus. The apparatus can comprise a processor and a memory storage device coupled to the processor, the memory storage device comprising instructions executable by the processor, which instructions when executed cause the apparatus to: receive an image frame associated with a vessel of a patient; identify, from the image frame based in part on one or more of a plurality of machine learning (ML) models, a location and characteristic of one or more side branches; and match the one or more side branches with one or more side branches identified from a series of images, wherein the image frame and the series of images are captured with different image modalities.

In further embodiments of the apparatus, the characteristic is an orientation of the one or more side branches, a diameter of the one or more side branches, or both an orientation and a width of the one or more side branches.

In further embodiments of the apparatus, the characteristics of orientation and diameter of the one or more side branches are inputs for a cross-modality side branch matching process between extravascular and intravascular imaging modalities, wherein the extravascular imaging modality is x-ray angiography or computed tomography angiography, and wherein the intravascular imaging modality is intravascular ultrasound or intravascular optical coherence tomography.

In further embodiments of the apparatus, the locations of the one or more side branches are inputs for a cross-modality side branch matching process between extravascular and intravascular imaging modalities, wherein the extravascular imaging modality is x-ray angiography or computed tomography angiography, and wherein the intravascular imaging modality is intravascular ultrasound or intravascular optical coherence tomography.

In further embodiments of the apparatus, the instructions when executed to identify the location and characteristic of the one or more side branches further causes the apparatus to: infer, using a first ML model of the plurality of ML models, a segmented version of the image frame, wherein the segmented version of the image frame comprises an indication of the vessel; infer, using a second ML model of the plurality of ML models, a straightened vessel from the vessel indicated in the segmented version of the image frame; and identify the one or more side branches from the straightened vessel.

In further embodiments of the apparatus, the instructions when executed to identify the one or more side branches from the straightened vessel further cause the apparatus to: split the straightened vessel into a left component and a right component; generate a first plot of connected pixels for the left component and generating a second plot of connected pixels for the right component; and determine the location of the one or more side branches based on first plot and the second plot.

In further embodiments of the apparatus, the instructions when executed to identify the one or more side branches from the straightened vessel further cause the apparatus to determine the width of the one or more side branches based on the first plot and the second plot.

In further embodiments of the apparatus, the instructions when executed to identify the one or more side branches from the straightened vessel further cause the apparatus to determine an orientation of the one or more side branches based on the first plot and the second plot.

In further embodiments of the apparatus, the instructions when executed to identify the one or more side branches from the straightened vessel further causes the apparatus to: trace, by the computing device, a skeleton of the straightened vessel; extract, by the computing device, a centerline of the straightened vessel from the skeleton; trace, by the computing device, the one or more side branches of the vessel based on the skeleton and the centerline; and determine a location of the one or more side branches of the vessel based on the tracing of the one or more side branches.

In further embodiments of the apparatus, the instructions when executed to identify the one or more side branches from the straightened vessel further causes the apparatus to determine the width of the one or more side branches based on the tracing of the one or more side branches.

In further embodiments of the apparatus, the instructions when executed to identify the one or more side branches from the straightened vessel further causes the apparatus to determine the orientation of the one or more side branches based on the tracing of the one or more side branches.

In further embodiments of the apparatus, the orientation is a left side or a right side orientation.

With some embodiments, the disclosure can be implemented as a computer-readable storage device. The computer-readable storage device can comprise instructions executable by a processor of a computing device coupled to an intravascular imaging device and a fluoroscope device, wherein when executed the instructions cause the computing device to: receive an image frame associated with a vessel of a patient; identify, from the image frame based in part on one or more of a plurality of machine learning (ML) models, a location and characteristic of one or more side branches; and match the one or more side branches with one or more side branches identified from a series of images, wherein the image frame and the series of images are captured with different image modalities.

In further embodiments of the computer-readable storage device, the characteristic is an orientation of the one or more side branches, a diameter of the one or more side branches, or both an orientation and a width of the one or more side branches.

In further embodiments of the computer-readable storage device, the instructions when executed to identify the location and characteristic of the one or more side branches further causes the computing device to: infer, using a first ML model of the plurality of ML models, a segmented version of the image frame, wherein the segmented version of the image frame comprises an indication of the vessel; infer, using a second ML model of the plurality of ML models, a straightened vessel from the vessel indicated in the segmented version of the image frame; and identify the one or more side branches from the straightened vessel.

In further embodiments of the computer-readable storage device, the instructions when executed to identify the one or more side branches from the straightened vessel further cause the computing device to: split the straightened vessel into a left component and a right component; generate a first plot of connected pixels for the left component and generating a second plot of connected pixels for the right component; and determine the location of the one or more side branches based on first plot and the second plot.

In further embodiments of the computer-readable storage device, the instructions when executed to identify the one or more side branches from the straightened vessel further cause the computing device to determine the width of the one or more side branches based on the first plot and the second plot.

In further embodiments of the computer-readable storage device, the instructions when executed to identify the one or more side branches from the straightened vessel further cause the computing device to determine an orientation of the one or more side branches based on the first plot and the second plot.

In further embodiments of the computer-readable storage device, the instructions when executed to identify the one or more side branches from the straightened vessel further causes the computing device to: trace, by the computing device, a skeleton of the straightened vessel; extract, by the computing device, a centerline of the straightened vessel from the skeleton; trace, by the computing device, the one or more side branches of the vessel based on the skeleton and the centerline; and determine a location of the one or more side branches of the vessel based on the tracing of the one or more side branches.

### BRIEF DESCRIPTION OF THE SEVERAL VIEWS OF THE DRAWINGS

To easily identify the discussion of any element or act, the most significant digit or digits in a reference number refer to the figure number in which that element is first introduced.

FIG. 1 illustrates a side branch detection system in accordance with at least one embodiment.

FIG. 2 illustrates a routine for straightening a vessel represented in an image frame in accordance with at least one embodiment.

FIG. 3 illustrates an example image frame and inferred segmented image frame in accordance with at least one embodiment.

FIG. 4 illustrates an example segmented image frame and inferred straightened vessel in accordance with at least one embodiment.

FIG. 5 illustrates a routine for extracting information about side branches of a vessel in accordance with at least one embodiment.

FIGS. 6A and 6B illustrate examples images of a vessel and side branches in accordance with at least one embodiment.

FIG. 7 illustrates a routine for extracting information about side branches of a vessel in accordance with at least one embodiment.

FIGS. 8A, 8B, 8C, 8D, and 8E illustrate example images of a vessel and side branches in accordance with at least one embodiment.

FIGS. 9A and 9B illustrates an exemplary artificial intelligence/machine learning (AI/ML) system suitable for use with at least one embodiment.

FIG. 10 illustrates a computer-readable storage medium in accordance with at least one embodiment.

FIG. 11 illustrates an example imaging system in accordance with at least one embodiment.

FIG. 12 illustrates a diagrammatic representation of a machine in the form of a computer system within which a set of instructions may be executed for causing the machine to perform any one or more of the methodologies discussed herein.

### DETAILED DESCRIPTION

As introduced above, the disclosure can be implemented to detect side branches and characteristics of the side branches from an angiographic image. In part, the present disclosure provides side branch detection using machine learning (ML) models. These ML models can be trained using angiography images from an annotated dataset, where the angiography images are labeled at the pixel-level. Further, the angiography images can be straightened along an area of interest (e.g., vessel centerline, or the like) to enhance the vessel structure representation. Subsequently, information (e.g., location index, size details, side branch orientation, etc.) can be extracted using post-processing techniques.

This provides a significant advantage over conventional co-registration workflows. For example, in current co-registration workflows, a user needs to manually adjust the locations of side branches on the angiography images to align them with side branches detected in the intravascular images. The present disclosure can be implemented to automatically identify the side branches in the angiography images thereby enabling automatic adjustment, which can further enhance the ease of use and user experience. Further, the present disclosure can be implemented to enable live co-registration, which is not possible with conventional co-registration workflows.

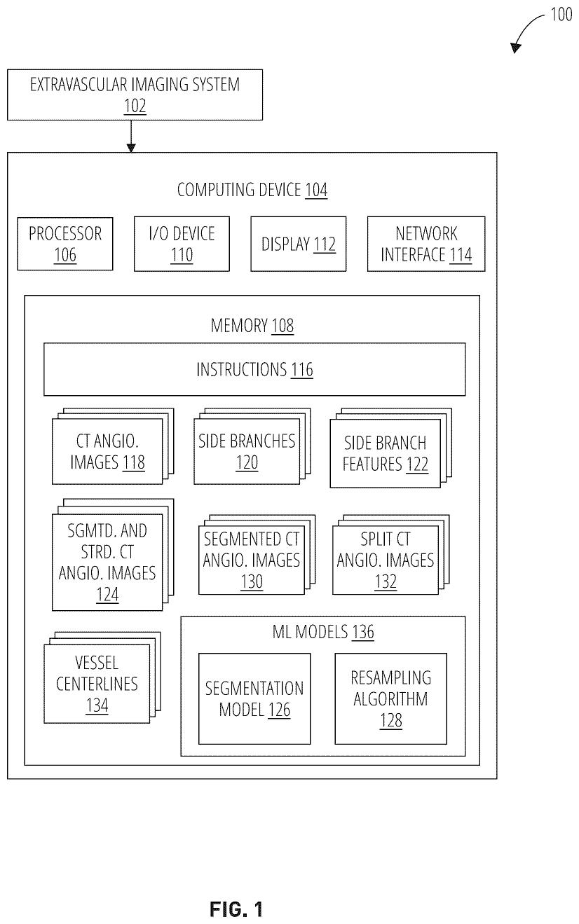

FIG. 1 illustrates a side branch detection system 100, in accordance with an embodiment of the present disclosure. In general, side branch detection system 100 is a system configured to identify side branches from an extravascular (e.g., angiographic, or the like) image of a vessel and to identify information about the identified side branches. In particular, the side branch detection system 100 is configured to receive CT angiography images 122 and identify the side branches 124 represented in the CT angiography images 122 and side branch features 126 of the side branches 124. Further, side branch detection system 100 can be configured to identify side branches 124 from a single angiographic image (e.g., one of CT angiography images 122) or a series of angiographic images (e.g., a cine loop, or the like). Additionally, as will be described herein, side branch detection system 100 is configured to generate straightened CT angiography images 128 from CT angiography images 122.

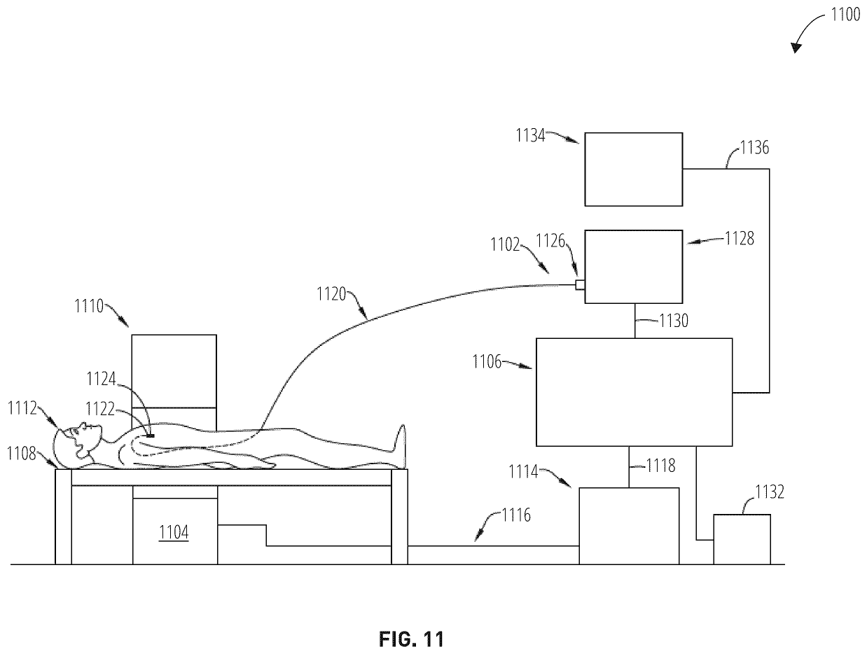

To that end, side branch detection system 100 includes, or can be coupled to, extravascular imaging system 102. Extravascular imaging system 102 can be any of a variety of angiographic imagers, an example of which is described with reference to the combined internal and external imaging system 1100 depicted in FIG. 11.

Further, side branch detection system 100 includes computing device 104. Computing device 104 can be any of a variety of computing devices. In some embodiments, computing device 104 can be incorporated into and/or implemented by a console of extravascular imaging system 102. With some embodiments, computing device 104 can be a tablet, laptop, workstation, or server communicatively coupled to extravascular imaging system 102. With still other embodiments, computing device 104 can be provided by a cloud based computing device, such as, by a Computing as a Service (CaaS) system accessibly over a network (e.g., the Internet, an intranet, a wide area network, or the like). Computing device 104 can include processor 110, memory 112, input and/or output (I/O) device 114, and network interface 118.

The processor 110 may include circuitry or processor logic, such as, for example, any of a variety of commercial processors. In some examples, processor 110 may include multiple processors, a multi-threaded processor, a multi-core processor (whether the multiple cores coexist on the same or separate dies), and/or a multi-processor architecture of some other variety by which multiple physically separate processors are in some way linked. Additionally, in some examples, the processor 110 may include graphics processing portions and may include dedicated memory, multiple-threaded processing and/or some other parallel processing capability. In some examples, the processor 110 may be an application specific integrated circuit (ASIC) or a field programmable integrated circuit (FPGA).

The memory 112 may include logic, a portion of which includes arrays of integrated circuits, forming non-volatile memory to persistently store data or a combination of non-volatile memory and volatile memory. It is to be appreciated, that the memory 112 may be based on any of a variety of technologies. In particular, the arrays of integrated circuits included in memory 112 may be arranged to form one or more types of memory, such as, for example, dynamic random access memory (DRAM), NAND memory, NOR memory, or the like.

I/O devices 114 can be any of a variety of devices to receive input and/or provide output. For example, I/O devices 114 can include, a keyboard, a mouse, a joystick, a foot pedal, a haptic feedback device, an LED, or the like. Display 116 can be a conventional display or a touch-enabled display. Further, display 116 can utilize a variety of display technologies, such as, liquid crystal display (LCD), light emitting diode (LED), or organic light emitting diode (OLED), or the like.

Network interface 118 can include logic and/or features to support a communication interface. For example, network interface 118 may include one or more interfaces that operate according to various communication protocols or standards to communicate over direct or network communication links. Direct communications may occur via use of communication protocols or standards described in one or more industry standards (including progenies and variants). For example, network interface 118 may facilitate communication over a bus, such as, for example, peripheral component interconnect express (PCIe), non-volatile memory express (NVMe), universal serial bus (USB), system management bus (SMBus), SAS (e.g., serial attached small computer system interface (SCSI)) interfaces, serial AT attachment (SATA) interfaces, or the like. Additionally, network interface 118 can include logic and/or features to enable communication over a variety of wired or wireless network standards (e.g., 802.11 communication standards). For example, network interface 118 may be arranged to support wired communication protocols or standards, such as, Ethernet, or the like. As another example, network interface 118 may be arranged to support wireless communication protocols or standards, such as, for example, Wi-Fi, Bluetooth, ZigBee, LTE, 5G, or the like.

Memory 112 can include instructions 120, CT angiography images 122, side branches 124, side branch features 126, straightened CT angiography images 128, machine learning (ML) models 130, segmented CT angiography images 136, and vessel centerlines 140. During operation, processor 110 can execute instructions 120 to cause computing device 104 to receive CT angiography images 122 from extravascular imaging system 102. In general, CT angiography images 122 are CT images of a patient's heart or portion of a patient heart captured after injection of a contrast agent into the patient's vasculature.

Processor 110 can further execute instructions 120 to cause computing device 104 to generate straightened CT angiography images 128 from ML models 130 and CT angiography images 122. Said differently, processor 110 can execute instructions 120 to infer straightened CT angiography images 128 from CT angiography images 122 using ML models 130. As noted, CT angiography images 122 can be a single image or multiple images in a series of images (e.g., cine loop, or the like). As such, straightened CT angiography images 128 will correspondingly be a single image or a series of images.

ML models 130 can include a segmentation model 132 and a straightening model 134. The segmentation model 132 can be configured to distinguish components of the CT angiography images 122 corresponding to the main vessel from components of the CT angiography images 122 corresponding to surrounding tissues and background. With some examples, segmentation model 132 can be configured to infer segmented CT angiography images 136 comprising an indication of the main vessel components.

The straightening model 134 can be configured to straighten the main vessel components represented in the segmented CT angiography images 136. Said differently, straightening model 134 can be configured to infer straightened CT angiography images 128 from segmented CT angiography images 136 and an indication of a centerline of the vessel (e.g., vessel centerlines 140). It is noted that identification of the vessel centerlines 140 can be determined using a variety of algorithms. However, the specifics of such algorithms are not the subject of this disclosure.

Processor 110 can further execute instructions 120 to identify side branches 124 and side branch features 126 from straightened CT angiography images 128. This is described in greater detail below. However, as a general overview, processor 110 can execute instructions 120 to split the straightened CT angiography images 128 into left and right side portions, represented as split CT angiography images 138. From the split CT angiography images 138 a move focused analysis on each side of the vessel can be carried out independently. That is, processor 110 can execute instructions 120 to extract the location index, size, and orientation of the side branches.

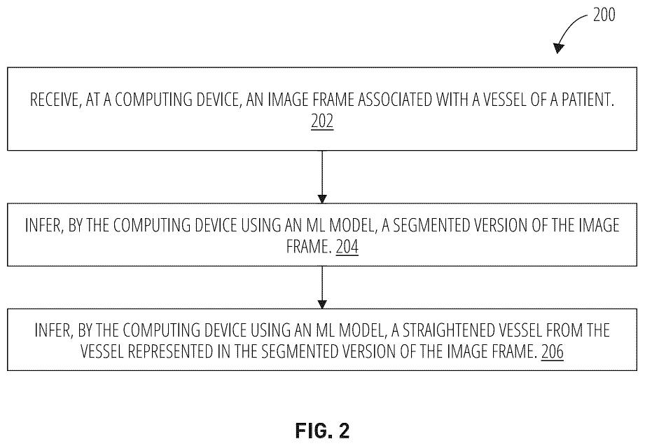

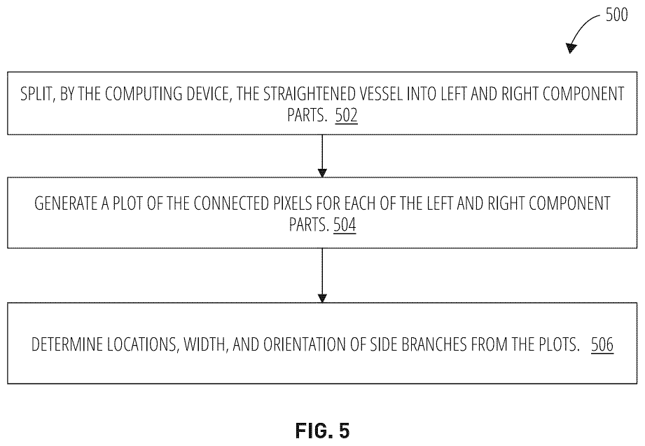

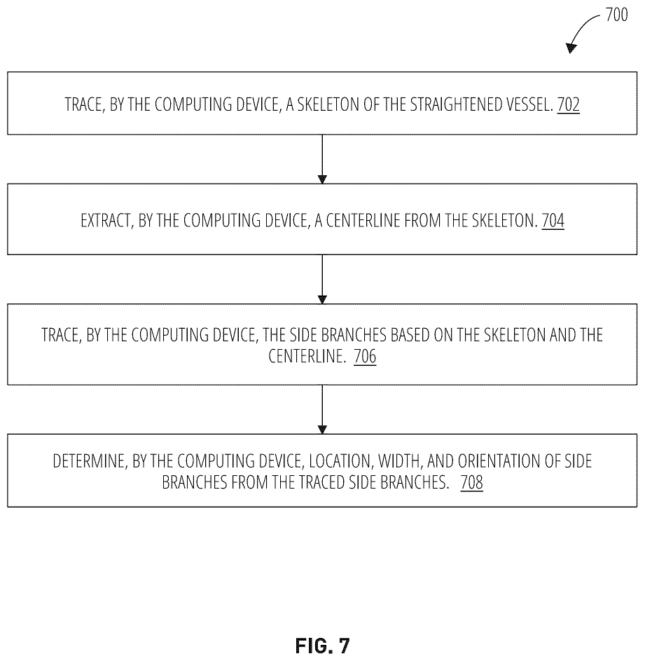

FIG. 2, FIG. 5, and FIG. 7 illustrate routines 200, 500, and 700 respectively, according to some embodiments of the present disclosure. Routines 200, 500, and 700 can be implemented by side branch detection system 100, or another computing device, as outlined herein to identify side branches of a vessel represented in an angiography image (or series of images) and information about the identified side branches. Routine 200 can be implemented to generate a straightened vessel from several CT angiography images of the vessel. Routines 500 and 700 can be implemented to extract locations and key information (e.g., width, orientation, or the like) of side branches from the straightened vessel. It is noted that routines 200, 500, and 700 are described with reference to a single angiography image. However, routines 200, 500, and 700 could be repeated iteratively on multiple angiography images. As another example, each block or step of routines 200, 500, and 700 could be performed on multiple angiography images.

Routine 200 can begin at block 202 “receive, at a computing device from an extravascular imaging device, an image frame associated with a vessel of a patient” an angiography image frame can be received at a computing device. For example, computing device 104 of side branch detection system 100 can receives an image frame of CT angiography images 122. With some embodiments, the frame of CT angiography images 122 can be receive from extravascular imaging system 102 while in other embodiments the frame of CT angiography images 122 can have been previously captured by extravascular imaging system 102 and stored in memory (e.g., memory 112, a memory location accessible over network interface 118). In such examples, computing device 104 can access the frame of CT angiography images 122 from the memory location. With some embodiments, processor 110 can execute instructions 120 to receive an indication from a user of the frame (or frames) of CT angiography images 122 to access at block 202.

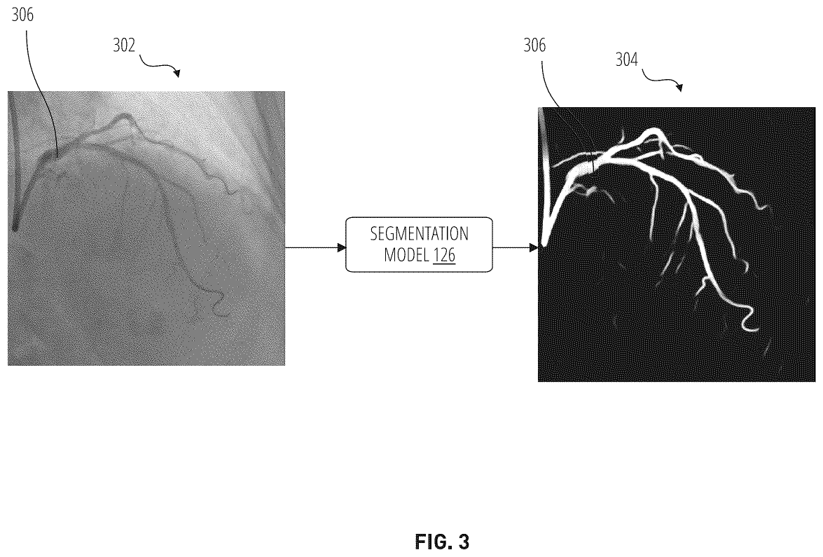

Continuing to block 204 “infer, by the computing device using an ML model, a segmented version of the image frame” a segmented version of the image frame can be inferred using an ML model. For example, processor 110 can execute instructions 120 to infer a frame of segmented CT angiography images 136 from the frame of CT angiography images 122 received at block 202 using segmentation model 132. An example of a frame from CT angiography images 122 and an associated frame of segmented CT angiography images 136, which can be generated as outlined herein, is given in FIG. 3, described in more detail below.

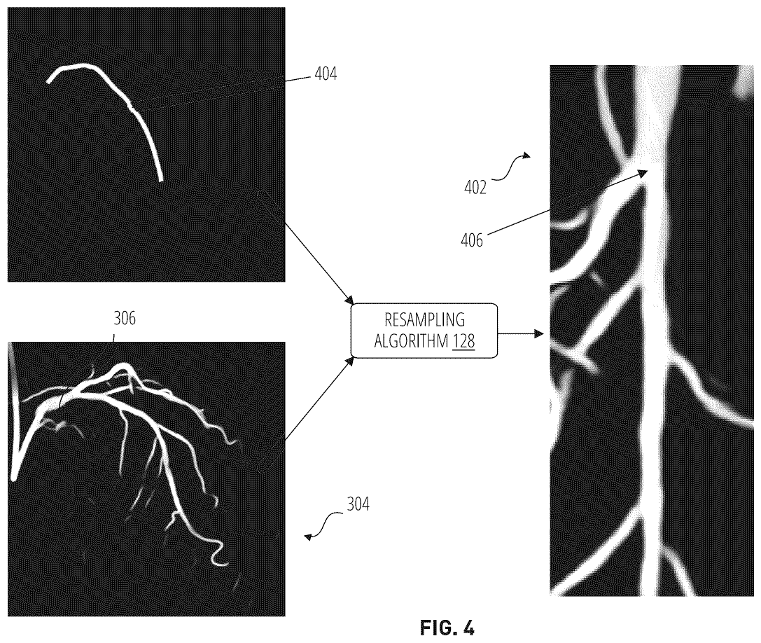

Continuing to block 206 “infer, by the computing device using an ML model, a straightened vessel from the vessel represented in the segmented version of the image frame” a straightened representation of the vasculature in the segmented frame can be inferred using an ML model. For example, processor 110 can execute instructions 120 to infer a frame of straightened CT angiography images 128 from the frame of segmented CT angiography images 136 inferred at block 204 using straightening model 134. With some embodiments, processor 110 can execute instructions 120 to infer straightened CT angiography images 128 from segmented CT angiography images 136 using straightening model 134 and vessel centerlines 140. An example of a frame from straightened CT angiography images 128 and an associated frame of segmented CT angiography images 136 as well as an indication of the centerline (e.g., from vessel centerlines 140), which can be generated as outlined herein, is given in FIG. 4, described in more detail below.

FIG. 3 depicts an example of a CT angiography frame 302, which can be inferred from segmentation model 132 using segmented CT angiography frame 304 as outlined herein. In some embodiments, CT angiography frame 302 and segmented CT angiography frame 304 can be a frame of CT angiography images 122 and straightened CT angiography images 128, respectively. As depicted, a vessel structure, or vasculature 306 is depicted in both CT angiography frame 302 and segmented CT angiography frame 304.

FIG. 4 depicts an example of a straightened CT angiography frame 402, which can be inferred from straightening model 134 using segmented CT angiography frame 304 and centerline 404 as outlined herein. In some embodiments, segmented CT angiography frame 304, straightened CT angiography frame 402, and centerline 404 can be a frame of segmented CT angiography images 136, straightened CT angiography images 128, and vessel centerlines 140, respectively. As depicted, the vasculature 306 represented in segmented CT angiography frame 304 is straightened in straightened CT angiography frame 402, resulting in straightened vessel 406.

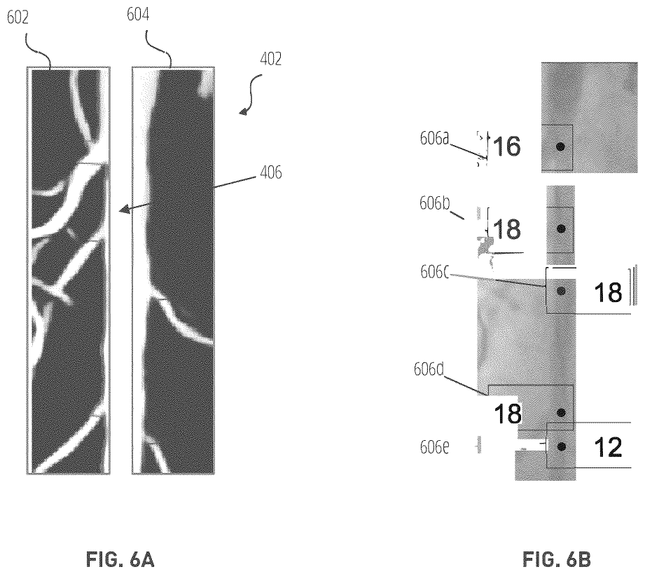

As noted, FIG. 5 illustrates routine 500, which can be implemented to extract locations and key information (e.g., width, orientation, or the like) of side branches from a straightened vessel. Routine 500 can begin at block 502. At block 502 “split, by the computing device, the straightened vessel into left and right component parts” the straightened vessel can be split into left and right component parts. For example, processor 110 can execute instructions 120 to generate split CT angiography images 138 comprising indications of left and right side components of the vessel in straightened CT angiography images 128. As a particular example, processor 110 can execute instructions 120 to divide, or cut, the straightened vessel (e.g., straightened vessel 406, or the like) into left and right components. An example of this is depicted in FIG. 6A.

FIG. 6A depicts an example of straightened CT angiography frame 402 and straightened vessel 406 split into left component 602 and right component 604. With some embodiments, processor 110 can execute instructions 120 to divide straightened vessel 406 down the centerline to form left component 602 and right component 604.

Returning to FIG. 5 and routine 500, which can continue from block 502 to block 504. At block 504 “generate a plot of the connected pixels for each of the left and right component parts” a plot of the connected pixels in the straightened segmented image for both the left and right component parts of the straightened vessel can be generated. For example, processor 110 can execute instructions 120 to generate a plot of the connected pixels in each of the left component 602 and right component 604 from straightened vessel 406 of straightened CT angiography frame 402 can be generated.

In some examples, processor 110 can execute instructions 120 to calculate the number of connected pixel starting from the top of the cutting line down to the bottom for each separated portion (e.g., left component 602 and right component 604, or the like). This results in two distinct plots that represent the main vessel profile on both the left and the right side of the vessel.

Continuing to block 506 “determine locations, width, and orientation of side branches from the plots” the locations, width, and orientation of the side branches can be determined. For example, processor 110 can execute instructions 120 to identify the locations of the side branches as well as key features (e.g., width, orientation, etc.) of the side branches. Processor 110 can execute instructions 120 to identify an increase in the number of connected pixels, which can indicate a side branch location at that location along the vessel. Visually, this increase can be represented as a peak in the plot. However, processor 110 can execute instructions 120 to identify whether the number of connected pixels increase over a baseline number a threshold level. Further, processor 110 can execute instructions 120 to identify the locations of the side branches along the vessel based on these peaks.

Further, processor 110 can execute instructions 120 to identify the width, or diameter, of the side branches based on the width of the peaks. Additionally, as the plot is divided into left and right components, the orientation of each branch can be identified.

FIG. 6B depicts an example of identified side branches 606a, 606b, 606c, 606d, and 606e along with an indication of their width and orientation. For example, side branches 606a, 606b, and 606d are indicated as having a left side orientation while side branches 606c and 606e are indicated as having a right side orientation. Further, the width of each side branch is indicated.

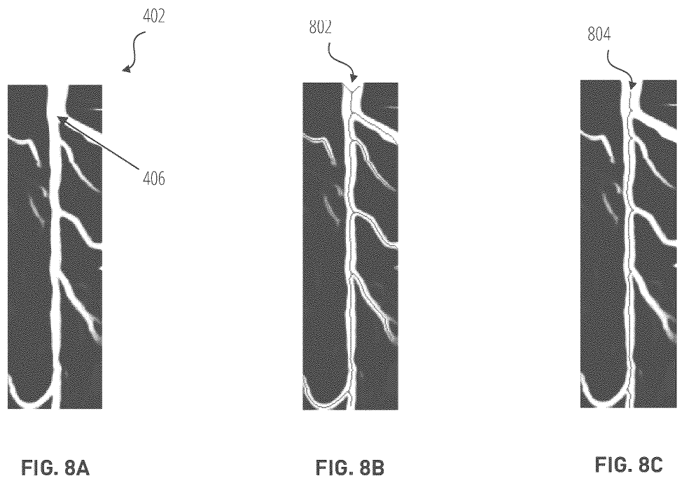

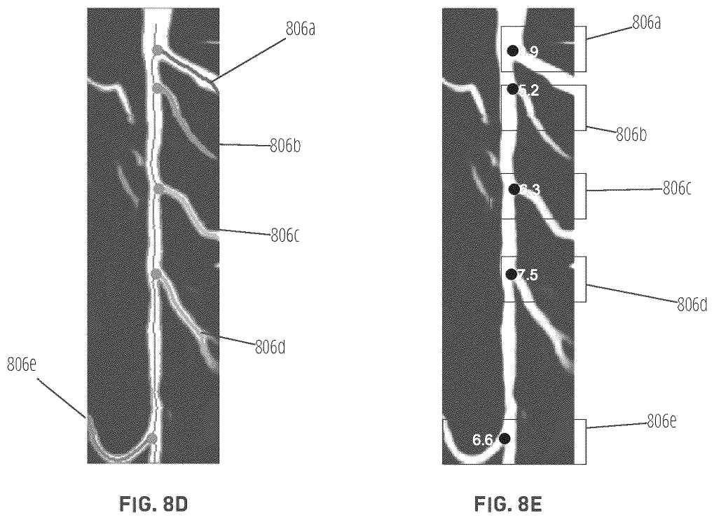

FIG. 7 illustrates routine 700, which can be implemented to extract locations and key information (e.g., width, orientation, or the like) of side branches from a straightened vessel. Routine 700 can begin at block 702. At block 702 “trace, by the computing device, a skeleton of the straightened vessel” a skeleton of the straightened vessel is traced by a computing device. For example, processor 110 can execute instructions 120 to trace the vessel represented in the straightened CT angiography images 128. An example of this is depicted in FIG. 8A and FIG. 8B.

FIG. 8A illustrates an example of straightened CT angiography frame 402 and straightened vessel 406 while FIG. 8B illustrates the straightened CT angiography frame 402 and a skeleton 802 of straightened vessel 406, which can be traced by processor 110 executing instructions 120.

Returning to FIG. 7 and routine 700, which can continue from block 702 to block 704. At block 704 “extract, by the computing device, a centerline from the skeleton” a centerline of the vessel can be extracted from the skeleton. For example, processor 110 can execute instructions 120 to extract a centerline from the skeleton 802. An example of this is depicted in FIG. 8C.

FIG. 8C illustrates an example of the straightened CT angiography frame 402 with a centerline 804 extracted from the skeleton 802. Returning to FIG. 7 and routine 700, which can continue from block 704 to block 706. At block 706 “trace, by the computing device, the side branches based on the skeleton and the centerline” side branches of the vessel can be traced based on the skeleton and centerline. For example, processor 110 can execute instructions 120 to trace the side branches of the straightened vessel 406 based on the skeleton 802 and the centerline 804. An example of this is depicted in FIG. 8D.

FIG. 8D illustrates an example of the straightened CT angiography frame 402 with side branches of the straightened vessel 406 traced based on the skeleton 802 and centerline 804. Side branches 806a, 806b, 806c, 806d, and 806e are depicted traced on the straightened vessel 406. Returning to FIG. 7 and routine 700, which can continue from block 706 to block 708. At block 708 “determine, by the computing device, location, width, and orientation of side branches from the traced side branches” the location, width, and orientation of the side branches can be determined from the traced side branches. For example, processor 110 can execute instructions 120 to extract information (e.g., location, width, orientation, etc.) about the side branches (e.g., side branch 806a, etc.) from the traced side branches. An example of this is depicted in FIG. 8E.

FIG. 8E depicts an example of identified side branches 806a, 806b, 806c, 806d, and 806c along with an indication of their width and orientation. For example, side branches 806a, 806b, 806c, and 806d are indicated as having a right side orientation while side branch 806e is indicated as having a left side orientation. Further, the width of each side branch is indicated.

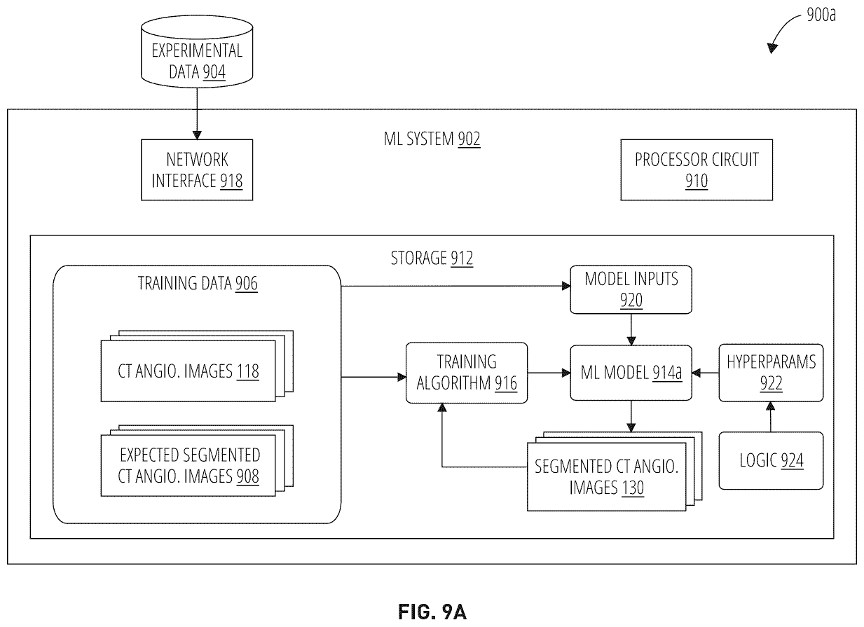

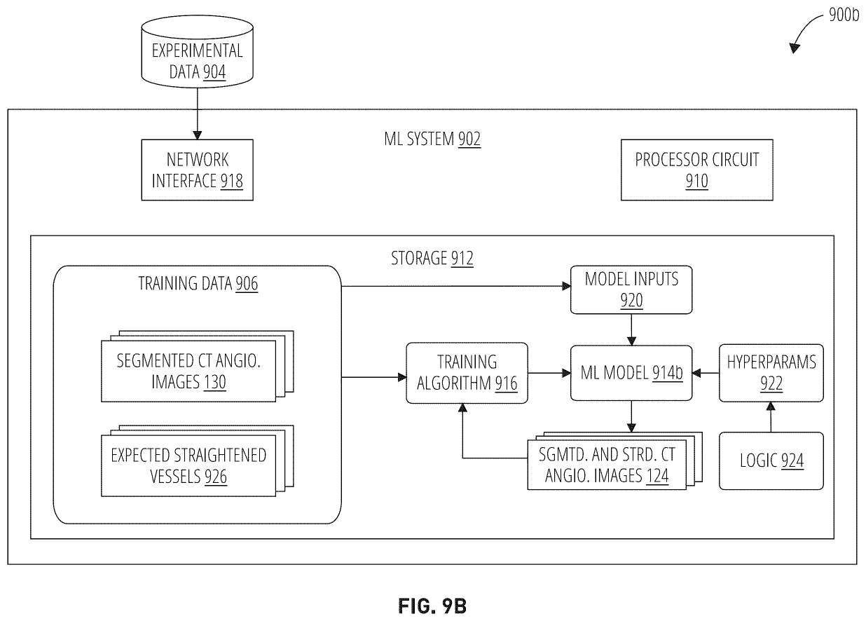

As noted, with some embodiments, an ML model can be utilized to infer a segmented images and a straightened vessel from the segmented images. For example, processor 110 of computing device 104 can execute instructions 120 to infer segmented CT angiography images 136 from CT angiography images 122 using ML models 130 (e.g., segmentation model 132, or the like) and to infer straightened CT angiography images 128 from segmented CT angiography images 136 using ML models 130 (e.g., straightening model 134, or the like). In such examples, the ML model (e.g., ML models 130) can be stored in memory 112 of computing device 104. It will be appreciated however, that prior to being deployed, the ML model is to be trained. FIG. 9A illustrates ML training environment 900a, which can be used to train an ML model that may later be used to generate (or infer) segmented CT angiography images 136 as described herein. The ML training environment 900a may include an ML System 902, such as a computing device that applies an ML algorithm to learn relationships. In this example, the ML algorithm can learn relationships between a set of inputs (e.g., CT angiography images 122) and an output (e.g., segmented CT angiography images 136).

The ML System 902 may make use of experimental data 904 gathered during several prior procedures. Experimental data 904 can include CT angiography images 122 for several patients. The experimental data 904 may be collocated with the ML System 902 (e.g., stored in a storage 912 of the ML System 902), may be remote from the ML System 902 and accessed via a network interface 918, or may be a combination of local and remote data.

Experimental data 904 can be used to form training data 906, which includes the CT angiography images 122 and corresponding pixel-level segmentations, which may be formed based on manual annotations, stored as expected segmented CT angiography images 908.

As noted above, the ML System 902 may include a storage 912, which may include a hard drive, solid state storage, and/or random access memory. The storage 912 may hold training data 906. In general, training data 906 can include information elements or data structures comprising indications of a CT angiography images 122 and associated expected segmented CT angiography images 908. The training data 906 may be applied to train an ML model 914a. Depending on the application, different types of models may be used to form the basis of ML model 914a. For instance, in the present example, an artificial neural network (ANN) may be particularly well-suited to learning associations between CT angiography images (CT angiography images 122) and segmented versions of the CT angiography images (e.g., segmented CT angiography images 136). Convoluted neural networks may also be well-suited to this task. Any suitable training algorithm 916 may be used to train the ML model 914a. Nonetheless, the example depicted in FIG. 9A may be particularly well-suited to a supervised training algorithm or reinforcement learning training algorithm. For a supervised training algorithm, the ML System 902 may apply the CT angiography images 122 as model inputs 920, to which expected segmented CT angiography images 908 may be mapped to learn associations between the CT angiography images 122 and the segmented CT angiography images 136. In a reinforcement learning scenario, training algorithm 916 may attempt to maximize some or all (or a weighted combination) of the model inputs 920 mappings to segmented CT angiography images 136 to produce ML model 914a having the least error. With some embodiments, training data 906 can be split into “training” and “testing” data wherein some subset of the training data 906 can be used to adjust the ML model 914a (e.g., internal weights of the model, or the like) while another, non-overlapping subset of the training data 906 can be used to measure an accuracy of the ML model 914a to infer (or generalize) segmented CT angiography images 136 from “unseen” training data 906 (e.g., training data 906 not used to train ML model 914a).

The ML model 914a may be applied using a processor circuit 910, which may include suitable hardware processing resources that operate on the logic and structures in the storage 912. The training algorithm 916 and/or the development of the trained ML model 914a may be at least partially dependent on hyperparameters 922. In exemplary embodiments, the model hyperparameters 922 may be automatically selected based on hyperparameter optimization logic 924, which may include any known hyperparameter optimization techniques as appropriate to the ML model 914a selected and the training algorithm 916 to be used. In optional, embodiments, the ML model 914a may be re-trained over time, to accommodate new knowledge and/or updated experimental data 904.

Once the ML model 914a is trained, it may be applied (e.g., by the processor circuit 910, by processor 110, or the like) to new input data (e.g., CT angiography images 122 captured during a pre-PCI intervention, a post-PCI intervention, or the like). This input to the ML model 914a may be formatted according to a predefined model inputs 920 mirroring the way that the training data 906 was provided to the ML model 914a. Trained model ML model 914a may generate segmented CT angiography images 136 from CT angiography images 122. In such examples, ML model 914a can be deployed as segmentation model 132.

The above description pertains to a particular kind of ML System 902, which applies supervised learning techniques given available training data with input/result pairs. However, the present invention is not limited to use with a specific ML paradigm, and other types of ML techniques may be used. For example, in some embodiments the ML System 902 may apply for example, evolutionary algorithms, or other types of ML algorithms and models to generate segmented CT angiography images 136 from CT angiography images 122.

ML System 902 can further be utilized to train a model to infer a straightened vessel from a segmented representation of the vasculature. FIG. 9B illustrates ML training environment 900b, which is an example of ML training environment 900a configured to train ML model 914b to infer straightened CT angiography images 128 from segmented CT angiography images 136. As such, training data 906 can include segmented CT angiography images 136 and expected straightened vessels 926 while ML model 914b can be “trained” as outlined above to infer straightened CT angiography images 128 from segmented CT angiography images 136. Trained model ML model 914b may generate straightened CT angiography images 128 from segmented CT angiography images 136. In such examples, ML model 914b can be deployed as straightening model 134.

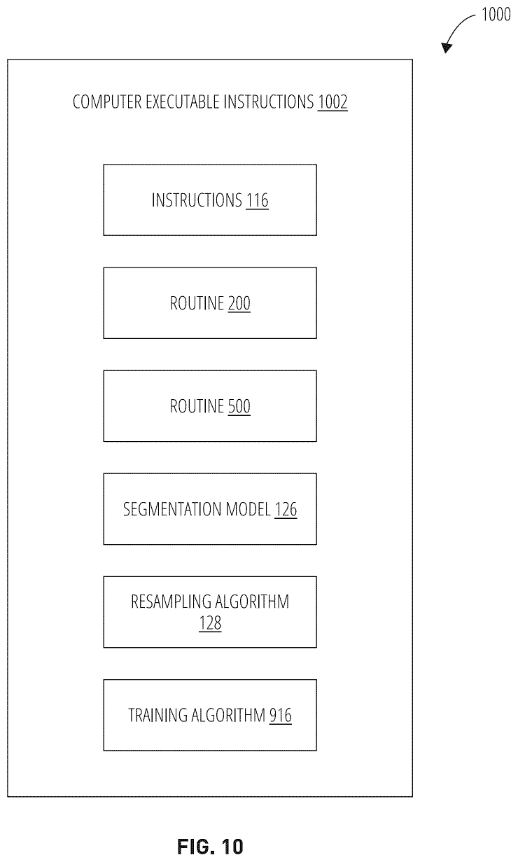

FIG. 10 illustrates computer-readable storage medium 1000. Computer-readable storage medium 1000 may comprise any non-transitory computer-readable storage medium or machine-readable storage medium, such as an optical, magnetic or semiconductor storage medium. In various embodiments, computer-readable storage medium 1000 may comprise an article of manufacture. In some embodiments, computer-readable storage medium 1000 may store computer executable instructions 1002 with which circuitry (e.g., processor 110, or the like) can execute. For example, computer executable instructions 1002 can include instructions to implement operations described with respect side branch detection system 100, which can improve the functioning of side branch detection system 100 as detailed herein. For example, computer executable instructions 1002 can include instructions that can cause a computing device to implemented routine 200 of FIG. 2, routine 500 of FIG. 5, training algorithm 916 of FIG. 9A and FIG. 9B. As another example, computer executable instructions 1002 can include instructions 120, segmentation model 132, and/or straightening model 134. Examples of computer-readable storage medium 1000 or machine-readable storage medium may include any tangible media capable of storing electronic data, including volatile memory or non-volatile memory, removable or non-removable memory, erasable or non-erasable memory, writeable or re-writeable memory, and so forth. Examples of computer executable instructions 1002 may include any suitable type of code, such as source code, compiled code, interpreted code, executable code, static code, dynamic code, object-oriented code, visual code, and the like.

FIG. 11 illustrates a combined internal and external imaging system 1100 including both an endoluminal imaging system 1102 (e.g., an IVUS imaging system, or the like) and an extravascular imaging system 1104 (e.g., an angiographic imaging system). Combined internal and external imaging system 1100 further includes computing device 1106, which includes circuitry, controllers, and/or processor(s) and memory and software as needed. With some embodiments, side branch detection system 100 can be incorporated into computing device 1106. In other embodiments, computing device 1106 can be configured to capture images (e.g., CT angiography images 122, or the like) for use in a side branch detection processor as described herein. It is to be appreciated that the systems and methods described herein do not need endoluminal imaging, that a combined imaging system is described for clarity of presentation. For example, the image identification techniques described herein to identify side branches of the vessel on an extravascular image can be used to co-register the extravascular image or images with a series of intravascular or endoluminal images. In general, the endoluminal imaging system 1102 can be arranged to generate intravascular imaging data (e.g., IVUS images, or the like) while the extravascular imaging system 1104 can be arranged to generate extravascular imaging data (e.g., angiography images, or the like).

The extravascular imaging system 1104 may include a table 1108 that may be arranged to provide sufficient space for the positioning of an angiography/fluoroscopy unit c-arm 1110 in an operative position in relation to a patient 1112 on the drive unit. C-arm 1110 can be configured to acquires fluoroscopic images in the absence of contrast agent in the blood vessels of the patient 1112 and/or acquire angiographic image while there is a presence of contrast agent in the blood vessels of the patient 1112.

Raw radiological image data acquired by the c-arm 1110 may be passed to an extravascular data input port 1114 via a transmission cable 1116. The input port 1114 may be a separate component or may be integrated into or be part of the computing device 1106. The input port 1114 may include a processor that converts the raw radiological image data received thereby into extravascular image data (e.g., angiographic/fluoroscopic image data), for example, in the form of live video, DICOM, or a series of individual images. The extravascular image data may be initially stored in memory within the input port 1114 or may be stored within memory of computing device 1106. If the input port 1114 is a separate component from the computing device 1106, the extravascular image data may be transferred to the computing device 1106 through the transmission cable 1116 and into an input port (not shown) of the computing device 1106. In some alternatives, the communications between the devices or processors may be carried out via wireless communication, rather than by cables as depicted.

The intravascular imaging data may be, for example, IVUS data or OCT data obtained by the endoluminal imaging system 1102. The endoluminal imaging system 1102 may include an intravascular imaging device such as an imaging catheter 1120. The imaging catheter 1120 is configured to be inserted within the patient 1112 so that its distal end, including a diagnostic assembly or probe 1122 (e.g., an IVUS probe), is in the vicinity of a desired imaging location of a blood vessel. A radiopaque material or marker 1124 located on or near the probe 1122 may provide indicia of a current location of the probe 1122 in a radiological image. In some embodiments, imaging catheter 1120 and/or probe 1122 can include a guide catheter (not shown) that has been inserted into a lumen of the subject (e.g., a blood vessel, such as a coronary artery) over a guidewire (also not shown). However, in some embodiments, the imaging catheter 1120 and/or probe 1122 can be inserted into the vessel of the patient 1112 without a guidewire.

With some embodiments, imaging catheter 1120 and/or probe 1122 can include both imaging capabilities as well as other data-acquisition capabilities. For example, FFR and/or iFR data, data related to pressure, flow, temperature, electrical activity, oxygenation, biochemical composition, or any combination thereof. In some embodiments, imaging catheter 1120 and/or probe 1122 can further include a therapeutic device, such as a stent, a balloon (e.g., an angioplasty balloon), a graft, a filter, a valve, and/or a different type of therapeutic endoluminal device.

Imaging catheter 1120 is coupled to a proximal connector 1126 to couple imaging catheter 1120 to image acquisition device 1128. Image acquisition device 1128 may be coupled to computing device 1106 via transmission cable 1116, or a wireless connection. The intravascular image data may be initially stored in memory within the image acquisition device 1128 or may be stored within memory of computing device 1106. If the image acquisition device 1128 is a separate component from computing device 1106, the intravascular image data may be transferred to the computing device 1106, via, for example, transmission cable 1116.

The computing device 1106 can also include one or more additional output ports for transferring data to other devices. For example, the computer can include an output port to transfer data to a data archive or memory device 1132. The computing device 1106 can also include a user interface (described in greater detail below) that includes a combination of circuitry, processing components and instructions executable by the processing components and/or circuitry to enable the image identification and vessel routing or pathfinding described herein and/or dynamic co-registration of intravascular and extravascular images using the identified vessel pathway.

In some embodiments, computing device 1106 can include user interface devices, such as, a keyboard, a mouse, a joystick, a touchscreen device (such as a smartphone or a tablet computer), a touchpad, a trackball, a voice-command interface, and/or other types of user interfaces that are known in the art.

The user interface can be rendered and displayed on display 1134 coupled to computing device 1106 via display cable 1136. Although the display 1134 is depicted as separate from computing device 1106, in some examples the display 1134 can be part of computing device 1106. Alternatively, the display 1134 can be remote and wireless from computing device 1106. As another example, the display 1134 can be part of another computing device different from computing device 1106, such as, a tablet computer, which can be coupled to computing device 1106 via a wired or wireless connection. For some applications, the display 1134 includes a head-up display and/or a head-mounted display. For some applications, the computing device 1106 generates an output on a different type of visual, text, graphics, tactile, audio, and/or video output device, e.g., speakers, headphones, a smartphone, or a tablet computer. For some applications, the user interface rendered on display 1134 acts as both an input device and an output device.

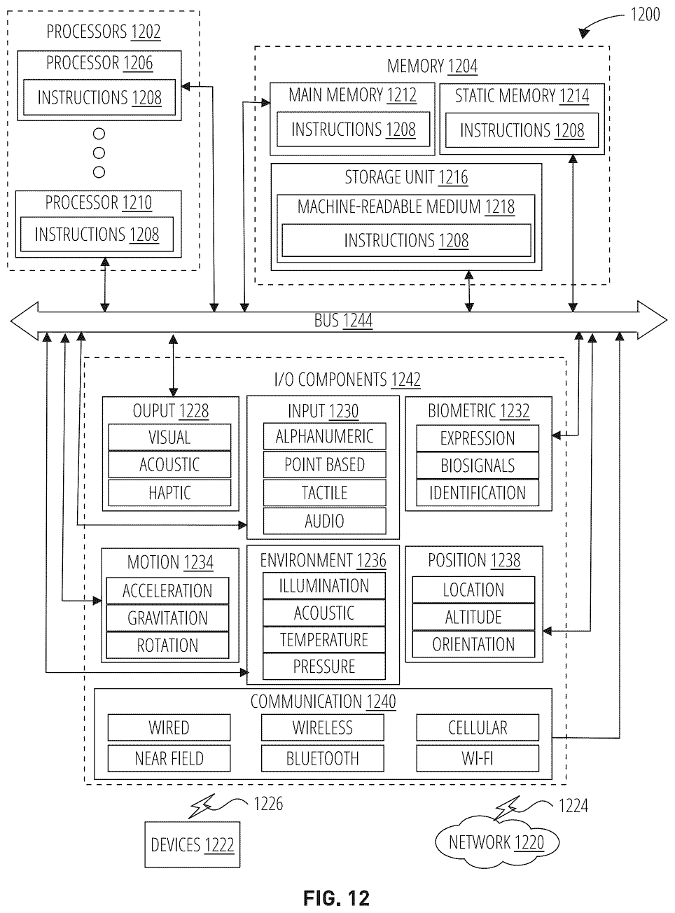

FIG. 12 illustrates a diagrammatic representation of a machine 1200 in the form of a computer system within which a set of instructions may be executed for causing the machine to perform any one or more of the methodologies discussed herein. More specifically, FIG. 12 shows a diagrammatic representation of the machine 1200 in the example form of a computer system, within which instructions 1208 (e.g., software, a program, an application, an applet, an app, or other executable code) for causing the machine 1200 to perform any one or more of the methodologies discussed herein may be executed. For example, the instructions 1208 may cause the machine 1200 to execute instructions 120, routine 200 of FIG. 2, routine 500 of FIG. 5, training algorithm 916 of FIG. 9A or FIG. 9B or the like. More generally, the instructions 1208 may cause the machine 1200 to identify side branches of a vessel from an CT angiography image (or images) of the vessel as described herein.

The instructions 1208 transform the general, non-programmed machine 1200 into a particular machine 1200 programmed to carry out the described and illustrated functions in a specific manner. In alternative embodiments, the machine 1200 operates as a standalone device or may be coupled (e.g., networked) to other machines. In a networked deployment, the machine 1200 may operate in the capacity of a server machine or a client machine in a server-client network environment, or as a peer machine in a peer-to-peer (or distributed) network environment. The machine 1200 may comprise, but not be limited to, a server computer, a client computer, a personal computer (PC), a tablet computer, a laptop computer, a netbook, a set-top box (STB), a PDA, an entertainment media system, a cellular telephone, a smart phone, a mobile device, a wearable device (e.g., a smart watch), a smart home device (e.g., a smart appliance), other smart devices, a web appliance, a network router, a network switch, a network bridge, or any machine capable of executing the instructions 1208, sequentially or otherwise, that specify actions to be taken by the machine 1200. Further, while only a single machine 1200 is illustrated, the term “machine” shall also be taken to include a collection of machines 200 that individually or jointly execute the instructions 1208 to perform any one or more of the methodologies discussed herein.

The machine 1200 may include processors 1202, memory 1204, and I/O components 1242, which may be configured to communicate with each other such as via a bus 1244. In an example embodiment, the processors 1202 (e.g., a Central Processing Unit (CPU), a Reduced Instruction Set Computing (RISC) processor, a Complex Instruction Set Computing (CISC) processor, a Graphics Processing Unit (GPU), a Digital Signal Processor (DSP), an ASIC, a Radio-Frequency Integrated Circuit (RFIC), another processor, or any suitable combination thereof) may include, for example, a processor 1206 and a processor 1210 that may execute the instructions 1208. The term “processor” is intended to include multi-core processors that may comprise two or more independent processors (sometimes referred to as “cores”) that may execute instructions contemporaneously. Although FIG. 12 shows multiple processors 1202, the machine 1200 may include a single processor with a single core, a single processor with multiple cores (e.g., a multi-core processor), multiple processors with a single core, multiple processors with multiples cores, or any combination thereof.

The memory 1204 may include a main memory 1212, a static memory 1214, and a storage unit 1216, both accessible to the processors 1202 such as via the bus 1244. The main memory 1204, the static memory 1214, and storage unit 1216 store the instructions 1208 embodying any one or more of the methodologies or functions described herein. The instructions 1208 may also reside, completely or partially, within the main memory 1212, within the static memory 1214, within machine-readable medium 1218 within the storage unit 1216, within at least one of the processors 1202 (e.g., within the processor's cache memory), or any suitable combination thereof, during execution thereof by the machine 1200.

The I/O components 1242 may include a wide variety of components to receive input, provide output, produce output, transmit information, exchange information, capture measurements, and so on. The specific I/O components 1242 that are included in a particular machine will depend on the type of machine. For example, portable machines such as mobile phones will likely include a touch input device or other such input mechanisms, while a headless server machine will likely not include such a touch input device. It will be appreciated that the I/O components 1242 may include many other components that are not shown in FIG. 12. The I/O components 1242 are grouped according to functionality merely for simplifying the following discussion and the grouping is in no way limiting. In various example embodiments, the I/O components 1242 may include output components 1228 and input components 1230. The output components 1228 may include visual components (e.g., a display such as a plasma display panel (PDP), a light emitting diode (LED) display, a liquid crystal display (LCD), a projector, or a cathode ray tube (CRT)), acoustic components (e.g., speakers), haptic components (e.g., a vibratory motor, resistance mechanisms), other signal generators, and so forth. The input components 1230 may include alphanumeric input components (e.g., a keyboard, a touch screen configured to receive alphanumeric input, a photo-optical keyboard, or other alphanumeric input components), point-based input components (e.g., a mouse, a touchpad, a trackball, a joystick, a motion sensor, or another pointing instrument), tactile input components (e.g., a physical button, a touch screen that provides location and/or force of touches or touch gestures, or other tactile input components), audio input components (e.g., a microphone), and the like.

In further example embodiments, the I/O components 1242 may include biometric components 1232, motion components 1234, environmental components 1236, or position components 1238, among a wide array of other components. For example, the biometric components 1232 may include components to detect expressions (e.g., hand expressions, facial expressions, vocal expressions, body gestures, or eye tracking), measure biosignals (e.g., blood pressure, heart rate, body temperature, perspiration, or brain waves), identify a person (e.g., voice identification, retinal identification, facial identification, fingerprint identification, or electroencephalogram-based identification), and the like. The motion components 1234 may include acceleration sensor components (e.g., accelerometer), gravitation sensor components, rotation sensor components (e.g., gyroscope), and so forth. The environmental components 1236 may include, for example, illumination sensor components (e.g., photometer), temperature sensor components (e.g., one or more thermometers that detect ambient temperature), humidity sensor components, pressure sensor components (e.g., barometer), acoustic sensor components (e.g., one or more microphones that detect background noise), proximity sensor components (e.g., infrared sensors that detect nearby objects), gas sensors (e.g., gas detection sensors to detection concentrations of hazardous gases for safety or to measure pollutants in the atmosphere), or other components that may provide indications, measurements, or signals corresponding to a surrounding physical environment. The position components 1238 may include location sensor components (e.g., a GPS receiver component), altitude sensor components (e.g., altimeters or barometers that detect air pressure from which altitude may be derived), orientation sensor components (e.g., magnetometers), and the like.

Communication may be implemented using a wide variety of technologies. The I/O components 1242 may include communication components 1240 operable to couple the machine 1200 to a network 1220 or devices 1222 via a coupling 1224 and a coupling 1226, respectively. For example, the communication components 1240 may include a network interface component or another suitable device to interface with the network 1220. In further examples, the communication components 1240 may include wired communication components, wireless communication components, cellular communication components, Near Field Communication (NFC) components, Bluetooth® components (e.g., Bluetooth® Low Energy), Wi-Fi® components, and other communication components to provide communication via other modalities. The devices 1222 may be another machine or any of a wide variety of peripheral devices (e.g., a peripheral device coupled via a USB).

Moreover, the communication components 1240 may detect identifiers or include components operable to detect identifiers. For example, the communication components 1240 may include Radio Frequency Identification (RFID) tag reader components, NFC smart tag detection components, optical reader components (e.g., an optical sensor to detect one-dimensional bar codes such as Universal Product Code (UPC) bar code, multi-dimensional bar codes such as Quick Response (QR) code, Aztec code, Data Matrix, Dataglyph, MaxiCode, PDF417, Ultra Code, UCC RSS-2D bar code, and other optical codes), or acoustic detection components (e.g., microphones to identify tagged audio signals). In addition, a variety of information may be derived via the communication components 1240, such as location via Internet Protocol (IP) geolocation, location via Wi-Fi® signal triangulation, location via detecting an NFC beacon signal that may indicate a particular location, and so forth.

The various memories (i.e., memory 1204, main memory 1212, static memory 1214, and/or memory of the processors 1202) and/or storage unit 1216 may store one or more sets of instructions and data structures (e.g., software) embodying or utilized by any one or more of the methodologies or functions described herein. These instructions (e.g., the instructions 1208), when executed by processors 1202, cause various operations to implement the disclosed embodiments.

As used herein, the terms “machine-storage medium,” “device-storage medium,” “computer-storage medium” mean the same thing and may be used interchangeably in this disclosure. The terms refer to a single or multiple storage devices and/or media (e.g., a centralized or distributed database, and/or associated caches and servers) that store executable instructions and/or data. The terms shall accordingly be taken to include, but not be limited to, solid-state memories, and optical and magnetic media, including memory internal or external to processors. Specific examples of machine-storage media, computer-storage media and/or device-storage media include non-volatile memory, including by way of example semiconductor memory devices, e.g., erasable programmable read-only memory (EPROM), electrically erasable programmable read-only memory (EEPROM), FPGA, and flash memory devices; magnetic disks such as internal hard disks and removable disks; magneto-optical disks; and CD-ROM and DVD-ROM disks. The terms “machine-storage media,” “computer-storage media,” and “device-storage media” specifically exclude carrier waves, modulated data signals, and other such media, at least some of which are covered under the term “signal medium” discussed below.

In various example embodiments, one or more portions of the network 1220 may be an ad hoc network, an intranet, an extranet, a VPN, a LAN, a WLAN, a WAN, a WWAN, a MAN, the Internet, a portion of the Internet, a portion of the PSTN, a plain old telephone service (POTS) network, a cellular telephone network, a wireless network, a Wi-Fi® network, another type of network, or a combination of two or more such networks. For example, the network 1220 or a portion of the network 1220 may include a wireless or cellular network, and the coupling 1224 may be a Code Division Multiple Access (CDMA) connection, a Global System for Mobile communications (GSM) connection, or another type of cellular or wireless coupling. In this example, the coupling 1224 may implement any of a variety of types of data transfer technology, such as Single Carrier Radio Transmission Technology (1×RTT), Evolution-Data Optimized (EVDO) technology, General Packet Radio Service (GPRS) technology, Enhanced Data rates for GSM Evolution (EDGE) technology, third Generation Partnership Project (3GPP) including 3G, fourth generation wireless (4G) networks, Universal Mobile Telecommunications System (UMTS), High Speed Packet Access (HSPA), Worldwide Interoperability for Microwave Access (WiMAX), Long Term Evolution (LTE) standard, others defined by various standard-setting organizations, other long range protocols, or other data transfer technology.

The instructions 1208 may be transmitted or received over the network 1220 using a transmission medium via a network interface device (e.g., a network interface component included in the communication components 1240) and utilizing any one of several well-known transfer protocols (e.g., hypertext transfer protocol (HTTP)). Similarly, the instructions 1208 may be transmitted or received using a transmission medium via the coupling 1226 (e.g., a peer-to-peer coupling) to the devices 1222. The terms “transmission medium” and “signal medium” mean the same thing and may be used interchangeably in this disclosure. The terms “transmission medium” and “signal medium” shall be taken to include any intangible medium that can store, encoding, or carrying the instructions 1208 for execution by the machine 1200, and includes digital or analog communications signals or other intangible media to facilitate communication of such software. Hence, the terms “transmission medium” and “signal medium” shall be taken to include any form of modulated data signal, carrier wave, and so forth. The term “modulated data signal” means a signal that has one or more of its characteristics set or changed in such a matter as to encode information in the signal.

Terms used herein should be accorded their ordinary meaning in the relevant arts, or the meaning indicated by their use in context, but if an express definition is provided, that meaning controls.

Herein, references to “one embodiment” or “an embodiment” do not necessarily refer to the same embodiment, although they may. Unless the context clearly requires otherwise, throughout the description and the claims, the words “comprise,” “comprising,” and the like are to be construed in an inclusive sense as opposed to an exclusive or exhaustive sense; that is to say, in the sense of “including, but not limited to.” Words using the singular or plural number also include the plural or singular number respectively, unless expressly limited to one or multiple ones. Additionally, the words “herein,” “above,” “below” and words of similar import, when used in this application, refer to this application as a whole and not to any portions of this application. When the claims use the word “or” in reference to a list of two or more items, that word covers all the following interpretations of the word: any of the items in the list, all the items in the list and any combination of the items in the list, unless expressly limited to one or the other. Any terms not expressly defined herein have their conventional meaning as commonly understood by those having skill in the relevant art(s).

What is claimed is:

1. An apparatus for a cross-modality side branch matching system, the apparatus, comprising:
a processor and a memory storage device coupled to the processor, the memory storage device comprising instructions executable by the processor, which instructions when executed cause the apparatus to:
receive an image frame associated with a vessel of a patient;
identify, from the image frame based in part on one or more of a plurality of machine learning (ML) models, a location and characteristic of one or more side branches; and
match the one or more side branches with one or more side branches identified from a series of images, wherein the image frame and the series of images are captured with different image modalities.

2. The apparatus of claim 1, wherein the characteristic is an orientation of the one or more side branches, a diameter of the one or more side branches, or both an orientation and a width of the one or more side branches.

3. The apparatus of claim 2, wherein the characteristics of orientation and diameter of the one or more side branches are inputs for a cross-modality side branch matching process between extravascular and intravascular imaging modalities,
wherein the extravascular imaging modality is x-ray angiography or computed tomography angiography, and
wherein the intravascular imaging modality is intravascular ultrasound or intravascular optical coherence tomography.

4. The apparatus of claim 2, wherein the locations of the one or more side branches are inputs for a cross-modality side branch matching process between extravascular and intravascular imaging modalities,
wherein the extravascular imaging modality is x-ray angiography or computed tomography angiography, and
wherein the intravascular imaging modality is intravascular ultrasound or intravascular optical coherence tomography.

5. The apparatus of claim 1, the instructions when executed to identify the location and characteristic of the one or more side branches further causes the apparatus to:
infer, using a first ML model of the plurality of ML models, a segmented version of the image frame, wherein the segmented version of the image frame comprises an indication of the vessel;
infer, using a second ML model of the plurality of ML models, a straightened vessel from the vessel indicated in the segmented version of the image frame; and
identify the one or more side branches from the straightened vessel.

6. The apparatus of claim 5, the instructions when executed to identify the one or more side branches from the straightened vessel further cause the apparatus to:
split the straightened vessel into a left component and a right component;
generate a first plot of connected pixels for the left component and generating a second plot of connected pixels for the right component; and
determine the location of the one or more side branches based on first plot and the second plot.

7. The apparatus of claim 6, the instructions when executed to identify the one or more side branches from the straightened vessel further cause the apparatus to determine the width of the one or more side branches based on the first plot and the second plot.

8. The apparatus of claim 7, the instructions when executed to identify the one or more side branches from the straightened vessel further cause the apparatus to determine an orientation of the one or more side branches based on the first plot and the second plot.

9. The apparatus of claim 22, the instructions when executed to identify the one or more side branches from the straightened vessel further causes the apparatus to:
trace, by the computing device, a skeleton of the straightened vessel;
extract, by the computing device, a centerline of the straightened vessel from the skeleton;
trace, by the computing device, the one or more side branches of the vessel based on the skeleton and the centerline; and
determine a location of the one or more side branches of the vessel based on the tracing of the one or more side branches.

10. The apparatus of claim 9, the instructions when executed to identify the one or more side branches from the straightened vessel further causes the apparatus to determine the width of the one or more side branches based on the tracing of the one or more side branches.

11. The apparatus of claim 10, the instructions when executed to identify the one or more side branches from the straightened vessel further causes the apparatus to determine the orientation of the one or more side branches based on the tracing of the one or more side branches.

12. The apparatus of claim 11, wherein the orientation is a left side or a right side orientation.

13. A computer-readable storage device, comprising instructions executable by a processor of a computing device coupled to an intravascular imaging device and a fluoroscope device, wherein when executed the instructions cause the computing device to:
receive an image frame associated with a vessel of a patient;
identify, from the image frame based in part on one or more of a plurality of machine learning (ML) models, a location and characteristic of one or more side branches; and
match the one or more side branches with one or more side branches identified from a series of images, wherein the image frame and the series of images are captured with different image modalities.

14. The computer-readable storage device of claim 13, wherein the characteristic is an orientation of the one or more side branches, a diameter of the one or more side branches, or both an orientation and a width of the one or more side branches.

15. The computer-readable storage device of claim 13, the instructions when executed to identify the location and characteristic of the one or more side branches further causes the computing device to:
infer, using a first ML model of the plurality of ML models, a segmented version of the image frame, wherein the segmented version of the image frame comprises an indication of the vessel;
infer, using a second ML model of the plurality of ML models, a straightened vessel from the vessel indicated in the segmented version of the image frame; and
identify the one or more side branches from the straightened vessel.

16. The computer-readable storage device of claim 15, the instructions when executed to identify the one or more side branches from the straightened vessel further cause the computing device to:
split the straightened vessel into a left component and a right component;
generate a first plot of connected pixels for the left component and generating a second plot of connected pixels for the right component; and
determine the location of the one or more side branches based on first plot and the second plot.

17. The computer-readable storage device of claim 16, the instructions when executed to identify the one or more side branches from the straightened vessel further cause the computing device to determine the width of the one or more side branches based on the first plot and the second plot.

18. The computer-readable storage device of claim 17, the instructions when executed to identify the one or more side branches from the straightened vessel further cause the computing device to determine an orientation of the one or more side branches based on the first plot and the second plot.

19. The computer-readable storage device of claim 18, the instructions when executed to identify the one or more side branches from the straightened vessel further causes the computing device to:
trace, by the computing device, a skeleton of the straightened vessel;
extract, by the computing device, a centerline of the straightened vessel from the skeleton;
trace, by the computing device, the one or more side branches of the vessel based on the skeleton and the centerline; and
determine a location of the one or more side branches of the vessel based on the tracing of the one or more side branches.

20. A method for a cross-modality side branch matching system, the method comprising:
receiving, at a computing device, an image frame associated with a vessel of a patient;
identifying, by the computing device, from the image frame based in part on one or more of a plurality of machine learning (ML) models, a location and characteristic of one or more side branches; and
matching, by the computing device, the one or more side branches with one or more side branches identified from a series of images, wherein the image frame and the series of images are captured with different image modalities.
